(19) United States
(12) Patent Application Publication
(10) Pub. No.: US 2005/0210686 A1
(43) Pub. Date: Sep. 29, 2005

(54) RECIPROCATING BLADE ATTACHMENTS INCLUDING WEIGHTED BALANCING

(76) Inventors: Jon Ritter, Cazadero, CA (US); Rebecca Ritter, Cazadero, CA (US)

Correspondence Address: GREENBERG & LIEBERMAN, 314 PHILADELPHIA AVE., TAKOMA PARK, MD, 20912, US

(21) Appl. No.: 10/908,631

(22) Filed: May 19, 2005

Related U.S. Application Data
(63) Continuation-in-part of application No. 11/037,888, filed on Jan. 18, 2005.
(63) Continuation-in-part of application No. PCT/US04/09432, filed on Mar. 29, 2004.

(51) Int. Cl. B27B 3/12

(52) U.S. Cl. 30/392

(57) ABSTRACT

A simple attachment for a reciprocating tool that will effectuate the ability to do a flush cut in an inexpensive and simple manner which is neither too rigid, nor not rigid enough. This is effectuated by providing an insert which fits into the reciprocating tool in the same fashion as a regular blade. The present invention then offsets the placement of a blade, sander, file, or other tool by as many inches as wished by the user. The blade, sander, file, or other tool is held rigid through the use of a 45 degree bracket spanning the distance from the original plane to the offset plane, or via a single or compound trapezoid design.

### PRIORITY AND CONTINUITY DATA

Priority is hereby claimed to PCT/US04/09432 filed on Mar. 30, 2004, as well as to 11/037,888 filed on Jan. 18, 2005.

### FIELD OF THE INVENTION

The present invention relates to an attachment for reciprocating tools, such as reciprocating saws. More particularly, the present is an offset attachment that permits a reciprocating tool to be fit with a variety of blades, sanders, and the like to attack a point from an offset angle.

### BACKGROUND OF THE INVENTION

Conventional reciprocating tools allow the user to attack a point straight on, or in other words, in a direct line from the tip of the reciprocating tool to the point. While a typical blade can be affixed in the center of the reciprocating tool, the body of the reciprocating tool oftentimes interferes with the surfaces around a point of attack.

For example, if a user wants to use a reciprocating tool to cut a two inch by two inch section in a dry wall area so that the two inch by two inch section is adjacent to a floor, the user cannot easily do so with a reciprocating tool. Because the saw blade extends out of the center front of the reciprocating tool, and the reciprocating tool has a bulky mass, the user can only make such a cut into the drywall at an angle away from ninety degrees. The best way to cut into the drywall is to maintain the saw blade perpendicular to the dry wall; however, because the reciprocating tool must remain above the floor, the user must approach the drywall so that the point of attack varies from ninety degrees from the drywall. Varying from a perpendicular point of attack, the user's cut is less reliable, less controlled, and encroaches into the drywall unevenly.

Restated, the problem is that the user cannot possibly position the reciprocating tool perpendicular to the drywall because the housing of the reciprocating tool must remain above the floor. There is a need for a device that allows reciprocating tool attachments perpendicular access to spaces wherein the mass of the reciprocating tool interferes with the normal point of attack.

In the past, users have attempted to create attachments capable of making cuts near an object while maintaining a perpendicular point of attack; however, such attachments have been either not rigid enough in order to effectuate a straight cut (that is, the saw attachments bend under the pressure of the saw attachments entering the drywall), have been too rigid thereby preventing the user from completing the cut all the way into a corner (that is, the saw attachments cannot be adjusted or interchanged as access to points of attack vary), or have been so complicated that they would break—and when broken, would be very expensive to fix. Thus, there is a need for a requisitely rigid offset attachment for a reciprocating tool that can be adjusted or interchanged easily that is not so complicated that the cost is prohibitive should it become damaged.

It has also been seen that, if there is sufficient weight, the use of an offset blade in the fashion previously described may create torque on the end of the blade or other tool that is placed in said offset, when the blade is moved back and forth. The torque is caused by a weight imbalance and results in the tool in the offset device to move in to a widening S shaped shimmy. Thus there is seen to be a need for an offset tool adapter that may be adjustable in the horizontal, and or vertical plane and uses adjustable weights to balance the increased or decreased weight of any tool placed in the offset adapter providing for movement without any shimmy.

U.S. Pat. No. 3,028,890 issued on Apr. 10, 1962, to G. E. Atkinson, et al. describes a power saw which accepts a blade in both the center position and offset on the edge of the blade holders. Atkinson's blade holder is inferior to the present invention as Atkinson's blade holder can only adjust to various positions in line with the power saw; it is ill suited to make a cut in a wall at the point where the wall touches the floor because there is very little room to maneuver the body of the power saw. Further, Atkinson's blade holder does not offer any extension of the blade forward, so that the power saw can remain a greater distance from the cut while cutting.

U.S. Pat. No. 3,260,290 issued on Jul. 12, 1966, to R. Happe , et al. describes a power saw attachment which accepts a blade for an offset position. However, Happe's device uses a guide rod which shortens the cut of the blade and does not allow the blade to be as flexible as desired. Further, Happe's device does not allow for different and varied blade placements and offsets.

U.S. Pat. No. 4,553,306 issued on Nov. 19, 1985 to Mineck describes a reciprocating offset blade. Although Mineck's offset blade adapter does allow for the blade to be placed in more then one position, one of which is that of the flush cut, Mineck's adapter does so through a complicated device that, once broken, is expensive to replace. Further, Mineck's adapter does not allow for different and varied blade placements and offsets, and does not extend the distance between the blade and the reciprocating tool.

Thus, there is a need for an offset tool adapter for a reciprocating tool capable of distancing offset tool attachments from the offset tool itself (i.e. adding inches onto the length of the offset tool attachment) while remaining stable. Further, there is a need for an offset tool adapter that allows various positioning so that the angle of attack to make a cut, etc. can be altered. Also, there is a need for an offset tool adapter that allows for quick interchangeability so that various offset tool attachments can be employed in short amount of time.

### SUMMARY OF THE INVENTION

The present invention is an attachment for reciprocating tools that allows blades, sanders, or any other device associated with a reciprocating tool to be quickly interchanged. The present invention has spaces common devices for reciprocating tools in different but parallel plane to the plane of the reciprocating tool. Thus, the user can access areas typically unreachable because with the present invention, the user can hold the reciprocating tool's body in a different plane than the device attached to the reciprocating tool. The present invention preferably has a 45 degree angle shift between the plane of the reciprocating tool and the plane of the device attached to the reciprocating tool. The angle provides a good blend of offset distance, structural integrity, and extension of the device ahead of the reciprocating tool. The distance of the angle shift is adjustable and can be used as a quick-change method. The length of the inline extension before the angle shift is also adjustable and weight may be added at end of the angle shift on either the outside or inside of the plane of the device attached to the reciprocating tool.

### BRIEF DESCRIPTION OF THE DRAWINGS

FIG. 1 is a right side view of a first embodiment of the present invention.

FIG. 2 is an environmental view a second embodiment of the present invention

FIG. 3 is a side view of a third embodiment of the present invention.

FIG. 4 is a side view of a fourth embodiment of the present invention.

FIG. 5 is a side view of the inline extension at maximum extension.

FIG. 6 is a side view of the inline extension at minimum extension.

FIG. 7 shows the offset of the present invention with balancing weight added in the opposite direction of the offset.

FIG. 8 is a top view of the present invention showing the offset to the right such that an attached tool moves adjacent to a reciprocating tool attached to the present invention.

FIG. 9-13 show multiple offset configurations of the present invention.

FIG. 14 is an environmental view of a bifurcated offset of the present invention.

### DETAILED DESCRIPTION

As seen in the attached drawings, the present invention is designed to be used with any power driven saw (10) having a reciprocating drive member (20). The present invention has an offset adapter (30) made up of a first, second, and third metal planes (40, 50, 60), two angle braces (70, 80), a conventional set screw (90), and a set screw receiving member (100).

The first straight metal plane (40) is designed to insert into the reciprocating drive member (20) and has the standard hole (25) used for locking any reciprocating saw blade into a reciprocating drive member (20). The second straight metal plane (50) is disposed anywhere from 90 degrees to 45 degrees from the first metal plane (40), and the second straight metal plane (50) is correspondingly attached to the third metal plane (60) anywhere from 90 degrees to 45 degrees from the third metal plane (60).

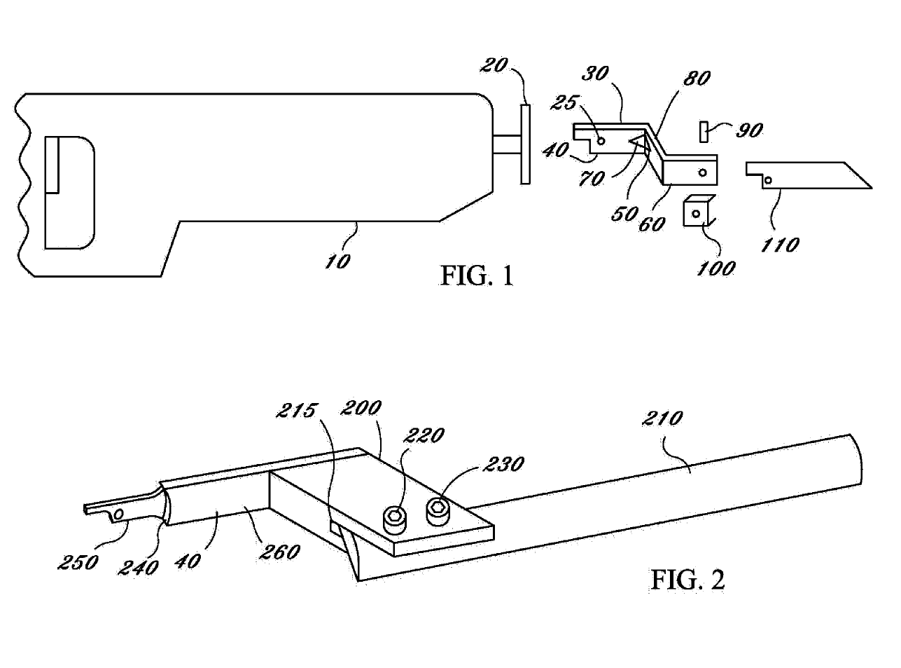

The first metal plane (40) and third metal plane (60) are, at all times, parallel with each other. In the embodiment shown in FIG. 1, the first, second, and third metal planes (40, 50, 60) are shown with a 90 degree connection. Between the first, second, and third metal planes (40, 50, 60) are angle braces (70, 80). These braces are designed to support the offset adapter (30) while still allowing the device to be flexible enough to access angles which are not normally accessible by the adapter (30). For example, if the user desires to use standard blade (110) to cut a hole in a wall, but the desired angle of approach to the wall cannot be achieved because of the relatively parallel arrangement of standard blade (110) and power driven saw (10), then angle braces (70, 80) flex to allow the user to engage the wall. In such case, once the user has inserted standard bland (110) into the wall, the user can pull or push power driven saw (10) so that angle braces (70, 80) flex—that is extend and compress—to create the desired angle of approach.

The first metal plane (40) in FIG. 1 is shown as a single solid piece of metal. In FIGS. 5 and 6 the plane (40) is made up of two overlapping pieces of metal (overlapping not shown) with one being a front piece (400) (this is basically a stock clamp bar) with a slot cut (410) into it and a back piece (420) which includes the part of the plane (40) which is designed to fit in to the reciprocating drive member (20). The front piece (400) attaches to the back piece (420) through the use of a thumb-screw (430) (optional, but it makes the whole assembly of the plane (40) much more secure) that fixedly attaches the front and back pieces (400, 420) together in an immoveable fashion when screwed tight. In FIGS. 5 and 6 we can also see the adjustment T screw (440) which is not optional, and which screws through the front and back pieces (400, 420) locking them in the users position of choice, and the two fixed mechanical fasteners (450). The fixed mechanical fasteners (450) are permanently embedded into the back piece (420) and the ends of said fasteners (420) emerge through the slot cut (410) in the first piece (400) allowing said first piece (400) and said back piece (420) to move slidingly against each other in the horizontal plane. The ends of the fasteners (450) are larger then the width of the slot cut (410) making it impossible for the front piece (400) and the back piece (420) to be separated even if the adjustment T screw (440) and or thumb-screw (430) are not screwed tight. In FIG. 5 the front piece (400) is fully extended and all of the screw holes (460) in the back piece (420) which the adjustment T screw (440) may screw in to are visible in the direction of the reciprocating drive member (20). In FIG. 6 the front piece (400) is not extended and all of the screw holes (460) in the back piece (420) which the adjustment T screw (440) may screw in to are not visible as they are covered by the front piece (400). In FIGS. 5 and 6 the end (470) of the back piece (420) can be seen through the slot (410). It should be noted that it is possible that the screw holes (460) could possibly be see through the slot cut (410) in this position even though they are not shown in FIG. 6. Additionally, although only two screw holes (460) are shown in FIG. 5, many more screw holes could be used to provide a greater variety in positioning and alternate methods of securing the particular position other then a screw method may be used including, though not limited to: ratcheting and an internal screw (both methods which would allow for much finer adjusting of the extension and therefore weight balancing) pins, pins with springs, swinging latches, top notching, etc. Also seen in both FIG. 5 and FIG. 6 are the standard hole (25) identical to the conventional hole used for locking any reciprocating saw blade into a reciprocating drive member (20). The purpose behind creating the ability of the first metal plane (40) to extend is to allow the weight of the offset (600) to be balanced through the use of the extension. It would of course be possible to balance the weight of the offset (600) by adding weight in the opposite direction (500) of the offset (600) as seen in FIG. 7 and this method although it is claimed herein, it is not the preferred method as use of this method only will require the same amount of weight to be placed on the opposite side (500) for the device to be correctly balanced. It is however believed that this method may be used in concert with the preferred method in order to fine-tune the balance. This of course may be effectuated with a much smaller amount of weight then previously discussed.

As has been intimidated, though not discussed in detail is the fact that a change in the weight of the offset (600) requires a change in the length of the first metal plane (40) in order to achieve the correct balance. In the current version of the invention (10) if the weight of the offset (600), which includes any attached tool combined is 0.72 lbs, then it will be balanced. The entire following math derives from this assumption as well as the environment being 600 RPM or 6.5 strokes per second.

It has been found that every time the first metal plane (40) is extended 1 inch, 0.04 lbs of weight must be removed from some part of the invention (10), which is not inline for the device to be balanced. This assumes no weight is being used in the opposite direction (500) of the offset (600) as previously discussed.

For example:

If the first metal plane (40) is extended by 4 inches then one would subtract 0.044 times or multiply 4×0.04 which would result in 0.16 lbs which is then subtracted from our base weigh of 0.72. providing us with 0.56 lbs. as the allowed weight on the offset (600) where in the offset (600) will be balanced. This would be written out mathematically as:
0.72−(4.0 in×0.04 lbs)=0.56 lb.

Interestingly enough, it has been found that the 0.72 lbs always corresponds to the 0.72° that is the angle of the second straight metal plane (50) when it is 1.5 inches in length. This therefore allows us to know any corresponding weight, distance or angle of the second straight metal plane (50) that will make the tool balance. For example:

With a first metal plane (40) being extended 12 inches and a second metal plane (50) that is 1.5 inches the formula would look as follows:
0.72−(12×0.04)=0.24

With a first metal plane (40) being extended 12 inches and a second metal plane (50) that is 2.0 inches the formula would look as follows:
((0.72−(12×0.04))/3)×4=0.32

It should of course be understood that when using these numbers we are working in a “perfect world” and that in the real world the same brand of saw or extension made with the same process from the same manufacturer will have different weights and as such a tolerance of plus or minus 0.1 lbs must be accepted. It is this tolerance, which makes the use of the ability to add a variable weight in the opposite direction (500) of the offset (600) in combination with the latter formula so attractive.

It should also be understood that a very light blade or tool may be put out on the market which would require weight to be added to the offset (600). Of course this weight could be added in a number of different spots and no particular spot on the inside of the offset (600) is superior to any other. One would of course not want to put any additional weight on the outside of the offset (600) in such a fashion as it would be impossible to place the offset (600) flat against the surface being cut. The configuration of the weight (not shown) which could be added may be of just about any configuration, however the preferred method would be thin metal plates which may attach magnetically to the offset (600) and which may be added in very small increments.

As can be seen from the prior discussion, it is contemplated that there would never be a saw or other attachment that would make the combined weight of the offset (600) more then 0.72 lbs. However, using the same concepts and similar math, the tool could be re-engineered to accept tools of any weight.

The third metal plane (60) is designed to accept a standard blade (110) in the same fashion as that of the reciprocating drive member (20) by using a conventional set screw (90) and a set screw receiving member (100). Set screw receiving member (100) is a U-shaped piece of metal that sandwiches standard blade (110) when standard blade (110) is held adjacent to third metal plane (60).

Alternative embodiments of the invention are many and varied. The first, second, and third metal planes (40, 50, 60), may be lengthened or shortened depending on the type of power driven saw (10) employed and depending on the additional offset length or reach desired. Further the angles between the first, second, and third metal planes (40, 50, 60) may also be changed in order to allow the user to make cuts at numerous angles. As the adapter (30) is inexpensive to manufacture, and is quite simple in design, many different lengths of first, second, and third metal planes (40, 50, 60) may be provided in a box in much the same fashion as drill bits are conventionally sold.

It should be noted that no matter the format of the adapter (30), it is always able to fit into a conventional power driven saw (10). As aforementioned, in FIG. 1, the standard hole (25) identical to the conventional hole used for locking any reciprocating saw blade into a reciprocating drive member (20) is shown.

An alternative embodiment of the present invention has second metal plane (50) and angle braces (70, 80) merged as one piece with greater girth, so that merged together, they appear as a trapezoid (200), as shown in FIG. 2. The trapezoid (200) provides even greater structural integrity than second metal plane (50) and angle braces (70, 80), if no flexing, as aforementioned, is desired. Optionally, trapezoid (200) could be made of a flexible material so that trapezoid (200) bends and flexes similar to second metal plane (50) and angle braces (70, 80). Trapezoid (200) is conventionally bolted to first metal plane (40).

Another embodiment of the present invention has third metal plane (60) deleted because trapezoid (200) is specially modified to communicate with file (210). This embodiment allows the adapter (30) to hold other implements such as file (210), sanders, or any other device that can fit in slot (21 5) and be conventionally bolted via first bolt (220) and second bolt (230).

An additional embodiment, as shown in FIG. 2, has a curved collar (240) that mates with the internal shape of reciprocating drive member (20) to form a curved fit that better holds first metal plane (40) in place. Preferably, curved collar (240) is a boundary between first section (250) of first metal plane (40) and second section (260) of first metal plane (40), such that first section (250) is narrower than second section (260).

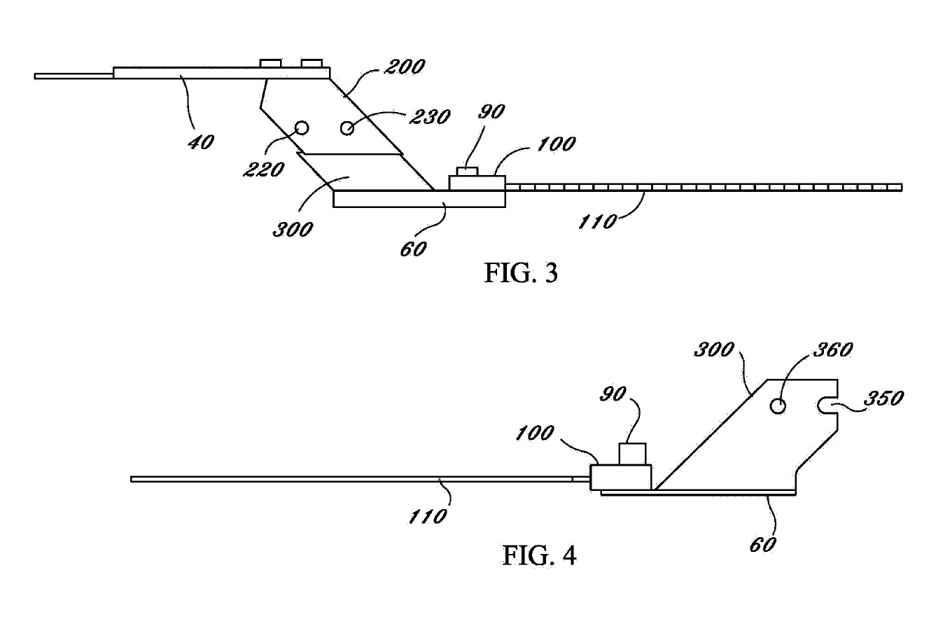

As shown in FIG. 3, another embodiment of the present invention has blade trapezoid (300) that is an extension mounted below and partially within trapezoid (200). This embodiment allows the adapter (30) to hold a standard blade (110) when trapezoid (200) is employed in place of second metal plane (50). Blade trapezoid (300) can fit in slot (215)—shown in FIG. 2—and be conventionally bolted within and to trapezoid (200) via first bolt (220) and second bolt (230). Blade trapezoid (300) communicates with third metal plane (60), in this embodiment, such that conventional set screw (90) and a set screw receiving member (100) sandwich standard blade (110) when standard blade (110) is held adjacent to third metal plane (60).

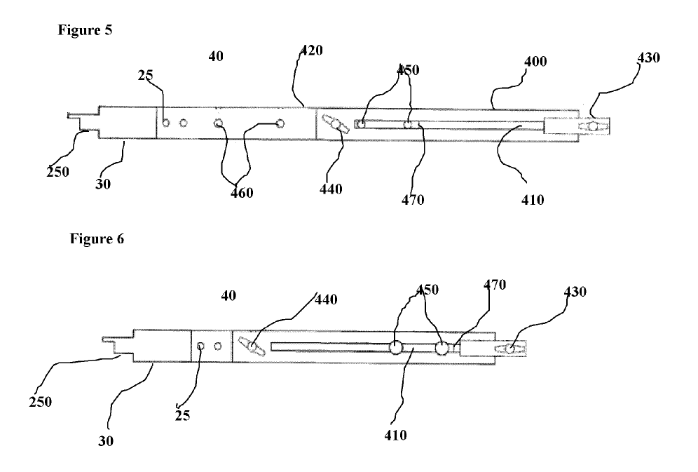

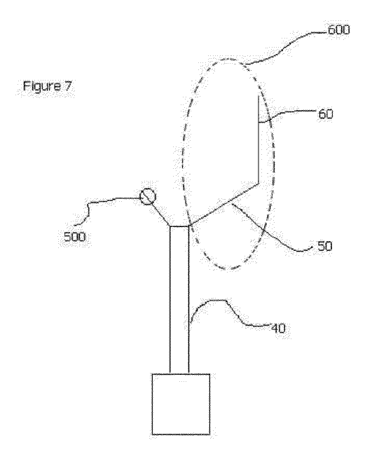

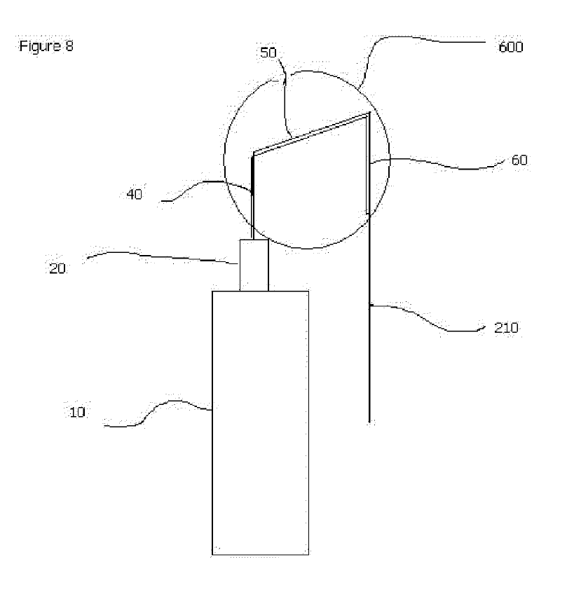

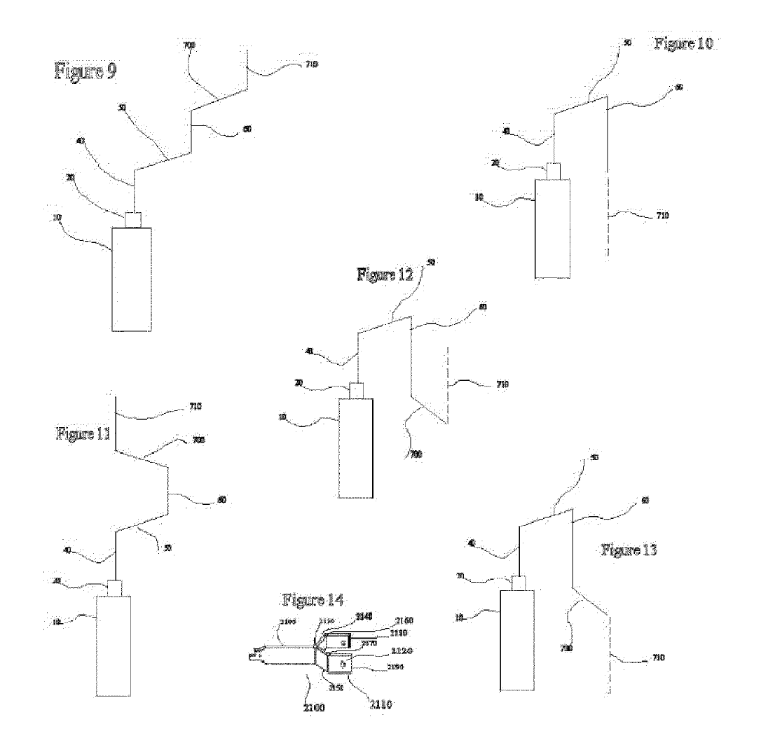

In another embodiment, second bolt (230) can be turned by the user's fingers to move through trapezoid (200) and contact blade trapezoid (300). This is significant because blade trapezoid (300)—as shown in FIG. 4—has first receiving aperture (350) that is merely an arc for receiving first bolt (220), whereas second receiving aperture (360) is actually a hole for receiving second bolt (230). The user can simply slide first receiving aperture (350) on and off first bolt (220) upon engaging and disengaging second receiving aperture (360) with second bolt (230), allowing for a “quick change” operation. Because of this quick change feature, blade trapezoid (300) can be fixed to other common tools such as sanders, files, and the like, in place of standard blade (110) to allow the user to quick change a variety of common tools and affix them to trapezoid (200).

In another embodiment the offset (600) may be rotated. In this case angle braces (70, 80) are replaced with a locking rotating screw (not shown). (Please note, a rotating screw which locks with a pin is conventionally known and there are numerous other methods to allow the active edge of the tool to be rotated. Of course, the piece that allows this rotation may be made an integral part of the device or may simply be an attachment that allows for the tool (700) itself to be attached to the attachment.) There are of course numerous methods of allowing this part of the device to turn and lock in many positions. Some of the known methods may be seen in US20040119352A1 or US4583907 among many others as well as the conventionally known ratchet and lock method used in many tools.

In another embodiment the offset (600) may be rotated at the joint where the third metal plane (60) and the second metal plane (50) meet. In this embodiment the third metal plane (60) may be attached and rotate in the exact same fashion as in the previous embodiment, i.e. through known methods. The advantage to this embodiment is that it allows the tool to affect a surface that is not only set away from the inline of the reciprocating saw, it also may do so to surfaces that are on different planes.

In another embodiment the third metal plane (60) of the offset (600) is attached in the same fashion as in any of the previous embodiments, however it (60) is designed to extend horizontally in line with the reciprocating saw. The advantage to this embodiment is it allows the use of the reciprocating saw in a hard to reach space, possibly behind a wall, pipe or other obstruction. This same embodiment may also include the former embodiment allowing the third metal plane (60) to rotate, allowing any of the surfaces to be affected.

In another embodiment the third metal plane (60) of the offset (600) is attached to the second metal plane (50) with a joint (not shown as known) which allows the third metal plane (60) to flex up to 30 degrees to the left or right of center and lock in any of such positions. It is further contemplated that the rotating capabilities discussed above may be insinuated preferably before though possibly after this joint.

In FIGS. 9-13 other embodiments can be seen where additional metal planes may be attached in any number of directions. In FIG. 9 a fourth (700) and a fifth (710) metal plane are attached in a fashion which extends the tool with an additional offset (600). In FIG. 10 the third metal plane (60) extends back down horizontally, though down toward the reciprocating saw (10), allowing cuts behind walls and other impediments. In FIG. 11 the a fourth (700) and fifth (710) metal planes are attached in the opposite direction of that shown in FIG. 9 allowing cuts on the other side of a smaller impediment, such as a pipe. In FIG. 12 the third metal plane (60) goes down towards the reciprocating saw (10) and the fourth (700) and a fifth (710) metal planes extend out and back up away from the reciprocating saw (10) allowing cuts further away from the saw (10). FIG. 13 is the same as FIG. 12, however the attached tool (700) extends down towards the saw (10) instead of up and away. All of these renditions are designed to allow the attached tool (700) to access almost any object desired by the user. The previously discussed ability for the active edge of the tool (700) to be pointed in any direction through the use of conventional means is also claimed as either an integral part of all the figures or as an attachment.

In another embodiment of the invention, multiple tools may be placed in the end of the offset (600) allowing for multiple cuts to be made at the same time. As shown in FIG. 14, an adjustable multiple attachment system (2100) allows at least two standard attachments (700) ) to be attached to one reciprocating saw (10) to be used simultaneously. The insertion point (2110) is the same as all attachments with a drill hole (2120). The multiple attachment system (2100) has base member (2105) extends 2″-3″ until it forks at first adjustable hinge (2130). Adjustable hinge (2130) allows first adjusting arm (2140) and second adjusting arm (2150) to adjust the width between the two standard attachments (700). On the opposite ends of first and second adjusting arms (2140 and 2150) are second adjustable hinge (2160) and third adjustable hinge (2170). Second and third adjustable hinges (2160 and 2170) allow third adjusting arm (2180) and fourth adjusting arm (2190) to adjust the Z-axis angle of the blade or paddle attachments. The standard attachments clamp onto the ends of third and fourth adjusting arms (2180 and 2190). Each of the adjustable hinges (2130, 2160 and 2170) and the attachment fasteners (2200 and 2210) are all controllable by a conventional thumb screw.

The present invention is not limited to the embodiments aforementioned, but encompasses any and all embodiments within the scope of the following claims.

1. A tool, comprising:
a first member in a first plane;
a second member in a second plane transverse to said first plane;
a third member in a third plane parallel to said first plane;
a means for adjusting said the length of said third member.

2. A tool, comprising:
a first member in a first plane;
a second member in a second plane transverse to said first plane;
a third member in a third plane parallel to said first plane; and
a means for adjusting said the length of said first member.

3. The device of claim 1, further comprising a means for adding weight to said first member.

4. The device of claim 1, further comprising a means for adding weight to said third member.

5. The device of claim 2, further comprising a means for adding weight to said first member.

6. The device of claim 2, further comprising a means for adding weight to said third member.

7. The device of claim 2, wherein as said first member is extended, said third member has the ability to lose weight.

8. The device of claim 1, wherein as said third member is extended, said first member has the ability to lose weight.

9. The device of claim 1, wherein said third member is at least bifurcated.

10. The device of claim 2, wherein said third member is at least bifurcated.

11. A tool, comprising:
a first member in a first plane;
a second member in a second plane transverse to said first plane;
a third member in a third plane parallel to said first plane; and
a means for providing rotation of said third member.

12. The device of claim 11, wherein said third member is at least bifurcated.
